(19) United States
(12) Patent Application Publication
(10) Pub. No.: US 2026/0261043 A1
(43) Pub. Date: Sep. 3, 2026

(54) RECONFIGURABLE REFLECTIVE SURFACES FOR INTERIOR SENSING

(71) Applicant: Robert Bosch GmbH, Stuttgart (DE)

(72) Inventors: Vivek JAIN, Sunnyvale, CA (US); Ruofeng LIU, East Lansing, MI (US)

(21) Appl. No.: 19/068,456

(22) Filed: Mar. 3, 2025

(51) Int. Cl. H01Q 3/46

(52) U.S. Cl. CPC H01Q 3/46

(57) ABSTRACT

Method and apparatus embodiments for controlling signal propagation in a wireless vehicle interior system using reconfigurable reflective surfaces is disclosed. A method includes transmitting wireless signals using a transmitter in a vehicle interior. Wireless signals are received at a receiver via line of sight (LOS) propagation, as well as by reflection off of configurable reflective surfaces. Data from reflected signals is compared to data from LOS signals, and a sensing state of the interior of the vehicle is determined, wherein the sensing state includes a number of vehicle occupants and may include other information as well. Based on the sensing state, parameters of the transmitter and the configurable reflective surfaces are adjusted to control the signal propagation within the vehicle.

### TECHNICAL FIELD

The present disclosure relates to wireless interior sensing applications, and more particularly, to reflective surfaces for wireless interior sensing applications.

### BACKGROUND

Smart vehicle cabin implementations can enhance the user experience for occupants of a vehicle and may further increase their safety. The in-cabin radar is a commonly used sensor in smart cabin implementations that can enable a wide range of applications including but not limited to child presence detection, occupancy detection/classification, driver impairment detection, etc. Available in-cabin radars may interrogate the cabin by transmitting a fixed, predefined waveform along a line of sight (LOS) and process the reception using a fixed algorithm.

### SUMMARY

Various method and apparatus embodiments for controlling signal propagation in a wireless vehicle interior sensing system are disclosed. In one embodiment, a method includes transmitting wireless signals using a transmitter implemented in the interior of a vehicle and reflecting at least a portion of the wireless signals using a plurality of configurable reflective surfaces implemented within the vehicle. The method further includes receiving, at a first receiver. The wireless signals include wireless signals conveyed via a line of sight between the transmitter and the first receiver and wireless signals reflected using the plurality of configurable reflective surfaces. Data generated based on receiving the wireless signals conveyed via the line of sight is compared to data generated based on the portion of the wireless signals reflected using the plurality of configurable reflective surfaces. Based on the comparing, the method includes determining a sensing state, wherein the sensing state includes a number of occupants in the interior of the vehicle. The method also includes adjusting operating parameters of the transmitter and the plurality of configurable reflective surfaces based on the sensing state. The operating parameters of the transmitter include controlling a direction of beams of wireless signals transmitted by the transmitter, and wherein the operating parameters of the plurality of configurable reflective surfaces include a frequency selectivity of the reflective surfaces.

### BRIEF DESCRIPTION OF THE DRAWINGS

FIG. 1 shows a system 100 for training a neural network.

FIG. 2 shows a computer-implemented method 200 for training a neural network.

FIGS. 3A-3C show various examples of a system for in-cabin sensing in a vehicle using reflective surfaces.

FIG. 4A shows a system for performing in-cabin sensing in a vehicle.

FIG. 4B shows another example of a system for performing in-cabin sensing in a vehicle.

FIG. 4C shows an example of reconfigurable reflective surfaces used in one embodiment of a system for performing in-cabin sensing in a vehicle.

FIGS. 5A-5E show various examples of a method for performing in-cabin sensing in a vehicle in accordance with the disclosure.

FIG. 6 depicts a schematic diagram of an interaction between computer-controlled machine 610 and control system 612.

FIG. 7 depicts a schematic diagram of the control system of FIG. 1 configured to control a vehicle and/or carry out in-cabin sensing functions.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

In-cabin sensing using wireless technologies (e.g., in-cabin radar) can provide a number of different applications within a vehicle. Such applications can include detecting the number of occupants in a vehicle, determining the presence of children in the vehicle, whether a vehicle operator is impaired, and so on. Similar applications may be implemented within a room in a building to, e.g., determine the number of occupants in the room, as well as other information. Many applications such as these uses wireless transmitters and receivers that detect signals via a line of sight or via incidental reflections.

The present disclosure utilizes Reconfigurable Intelligent Surfaces (RIS) as an enabling candidate wireless technology for the control of reflection of the wireless signals between a transmitter and a receiver in a dynamic and goal-oriented way. RIS may be implemented using mostly passive components to obtain low implementation cost and energy consumption. RIS includes a planar surface having an array of passive reflecting elements, each of which can independently impose the required phase shift on the incoming signal. A RIS implementation may be installed on flat surfaces (e.g., the ceiling in a vehicle, walls or ceilings within a building, and so on) to reflect wireless signals/radio frequency (RF) energy around obstacles and create a propagation path between a source and the destination. Creating such paths may mitigate blockage of high-frequency wireless signals, and may also enable new use cases. For example, RIS as disclosed herein may implement a solution for enhancing the coverage of a mmWave/THz network. Typical applications at these wavelengths/frequencies utilize MIMO (multiple input, multiple output), but may suffer from blockage problems due to narrow beams. While increasing the number of deployed wireless devices may eliminate some blockages, it may also increase the cost and complexity of the wireless infrastructure while also increasing power consumption. However, RIS as disclosed herein may provide a solution that is more cost effective and power efficient through the use of controlled reflections enabled thereby.

Accordingly, RIS as implemented in accordance with the present disclosure may enhance signal coverage in various weak coverage scenarios by providing an additional or alternative set of beams for wireless signals in the network. Enhanced spectral efficiency may be realized by boosting received signal power, increasing spatial multiplexing rank, and suppression of inter-cell interference. Security may also be enhanced by utilizing RIS to redirect reflections to trusted regions, thereby reducing data leakage to potential eavesdroppers. RIS implementations according to the disclosure may be used to assist localization that may otherwise be limited by the availability of various lines of sight and, in the case of cellular implementations, the availability of base stations. RIS-assisted sensing may enable the sensing of targets without wireless LOS connections. Even when LOS connections are available, RIS may enable sensing to be conducted from multiple angles to yield additional information regarding the environment.

As noted above, RIS according to the disclosure includes a planar surface having an array of reflecting elements. Each of the reflecting elements may independently impose the required phase shift on the incoming signal. By adjusting the phase shifts using various reflective elements, the reflected signals can be redirected to propagate toward in desired directions. Additional details of an example RIS unit are discussed below.

In an embodiment, a system for performing sensing within a vehicle includes a transmitter configured to transmit wireless signals within the vehicle and a receiver configured to receive the wireless signals transmitted within the vehicle. The system further includes a RIS having the configurable reflective surfaces configured to reflect at least a portion of the wireless signals transmitted by the transmitter. A control system is coupled to the transmitter, the receiver, and the RIS, and is configured to process line of sight data based on wireless signals that were not reflected prior to being received by the receiver and process reflected data based on wireless signals that were reflected from one or more of the plurality of reflected surfaces prior to being received by the receiver. The control system is further configured to determine a sensing state within the vehicle based on processed line of sight data and processed reflected data and adjust operating parameters of the transmitter and one or more of the reflective surfaces based on the sensing state.

As defined herein, a sensing state is a state of the environment in which the sensing is being conducted and may include the number of occupants, classification of various occupants, condition of the occupants, and so on. In embodiments not confined to the interior of a vehicle, the sensing state may include information regarding, e.g., the exterior of a vehicle, the interior of a room, and so on.

Various examples of systems and methods in accordance with the disclosure are now discussed in further detail below.

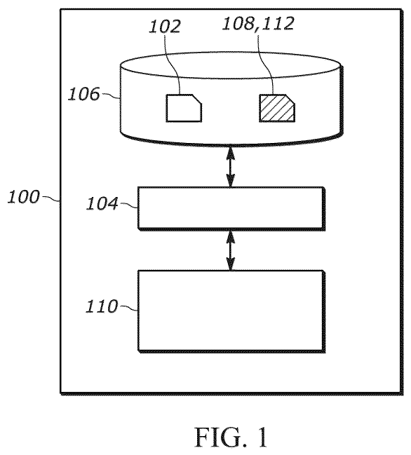

FIG. 1 shows a system 100 for training a neural network, e.g., a deep neural network. The neural network or deep neural networks shown and described are merely examples of the types of machine learning networks or neural networks that can be used. The system 100 may comprise an input interface for accessing training data 102 for the neural network. For example, as illustrated in FIG. 1, the input interface may be constituted by a data storage interface 104 which may access the training data 102 from a data storage 106. For example, the data storage interface 104 may be a memory interface or a persistent storage interface, e.g., a hard disk or an SSD interface, but also a personal, local or wide area network interface such as a Bluetooth, Zigbee or Wi-Fi interface or an Ethernet or fiber optic interface. The data storage 106 may be an internal data storage of the system 100, such as a hard drive or SSD, but also an external data storage, e.g., a network-accessible data storage.

In some embodiments, the data storage 106 may further comprise a data representation 108 of an untrained version of the neural network which may be accessed by the system 100 from the data storage 106. It will be appreciated, however, that the training data 102 and the data representation 108 of the untrained neural network may also each be accessed from a different data storage, e.g., via a different subsystem of the data storage interface 104. Each subsystem may be of a type as is described above for the data storage interface 104. In other embodiments, the data representation 108 of the untrained neural network may be internally generated by the system 100 on the basis of design parameters for the neural network, and therefore may not explicitly be stored on the data storage 106. The system 100 may further comprise a processor subsystem 110 which may be configured to, during operation of the system 100, provide an iterative function as a substitute for a stack of layers of the neural network to be trained. Here, respective layers of the stack of layers being substituted may have mutually shared weights and may receive as input an output of a previous layer, or for a first layer of the stack of layers, an initial activation, and a part of the input of the stack of layers. The processor subsystem 110 may be further configured to iteratively train the neural network using the training data 102. Here, an iteration of the training by the processor subsystem 110 may comprise a forward propagation part and a backward propagation part. The processor subsystem 110 may be configured to perform the forward propagation part by, amongst other operations defining the forward propagation part which may be performed, determining an equilibrium point of the iterative function at which the iterative function converges to a fixed point, wherein determining the equilibrium point comprises using a numerical root-finding algorithm to find a root solution for the iterative function minus its input, and by providing the equilibrium point as a substitute for an output of the stack of layers in the neural network. The system 100 may further comprise an output interface for outputting a data representation 112 of the trained neural network, this data may also be referred to as trained model data 112. For example, as also illustrated in FIG. 1, the output interface may be constituted by the data storage interface 104, with said interface being in these embodiments an input/output (‘IO’) interface, via which the trained model data 112 may be stored in the data storage 106. For example, the data representation 108 defining the ‘untrained’ neural network may during or after the training be replaced, at least in part by the data representation 112 of the trained neural network, in that the parameters of the neural network, such as weights, hyper parameters and other types of parameters of neural networks, may be adapted to reflect the training on the training data 102. This is also illustrated in FIG. 1 by the reference numerals 108, 112 referring to the same data record on the data storage 106. In other embodiments, the data representation 112 may be stored separately from the data representation 108 defining the ‘untrained’ neural network. In some embodiments, the output interface may be separate from the data storage interface 104, but may in general be of a type as described above for the data storage interface 104.

In various embodiments, the system for training a neural network may be implemented in a wireless interior sensing system used in a vehicle. Data may be obtained from the transmission and reception of wireless signals in the interior of the vehicle. Some signals are received via line of sight between the transmitter and the receiver. Other signals are reflected from the transmitter to the receiver by RIS as disclosed herein. Data from signals received via line of sight are compared to data from reflected signals. Using this information, the system may determine a number of occupants of the vehicle, classification of occupants (e.g., adult, child, pet, etc.), and in some cases, identification of the occupants, condition of the occupants, and so on. The information gained from these comparisons may also be used to adjust parameters of the transmitter, the receiver, and or the RIS. For example, beamforming of transmitted signals may be carried out in one embodiment to control the direction of signals, while the reflective surfaces may be reconfigured to control the direction of reflections such that signals are received with a greater signal-to-noise ratio. This may improve the operation of sensing the interior state of the vehicle. The various operations may be controlled using, e.g., machine learning models that are trained (and updated) using data obtained from the received signals and the comparisons between the line of sight signal data and the reflected signal data.

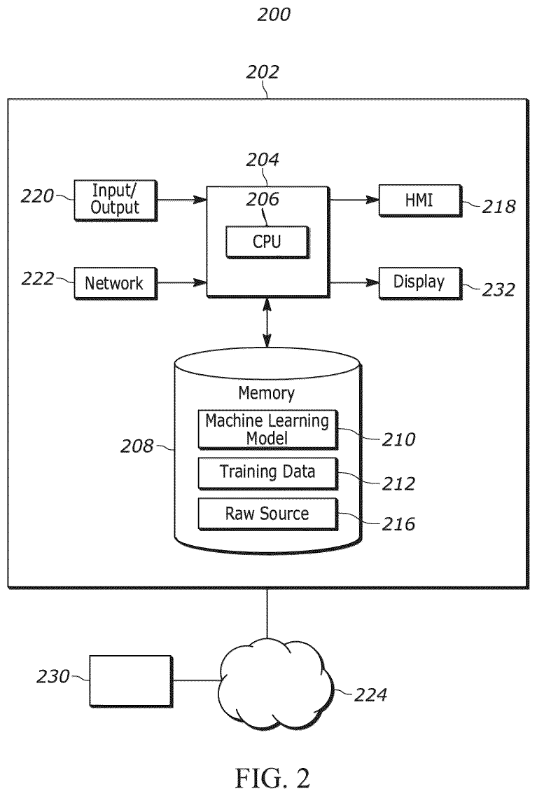

FIG. 2 depicts a computing system 200 to implement the machine learning models described herein, for example the deep neural networks used in performing various vehicle interior sensing system functions using data obtained from received wireless signals as described above and in further detail below. Other types of machine learning models can be used, and the DNNs described herein are not the only types of machine learning models capable of being used in the system of this disclosure. For example, if the input data includes image information having an ordered sequence of pixels after converting CSI values to pixels in an image, a CNN may be utilized. The system 200 can be implemented to perform one or more of operations associated with wireless vehicle interior sensing as described herein.

The system 200 may include at least one computing system 202. The computing system 202 may include at least one processor 204 that is operatively connected to a memory unit 208. The processor 204 may include one or more integrated circuits that implement the functionality of a central processing unit (CPU) 206. The CPU 206 may be a commercially available processing unit that implements an instruction set such as one of the x86, ARM, Power, or MIPS instruction set families. During operation, the CPU 206 may execute stored program instructions that are retrieved from the memory unit 208. The stored program instructions may include software that controls operation of the CPU 206 to perform the operation described herein. In some examples, the processor 204 may be a system on a chip (SoC) that integrates functionality of the CPU 206, the memory unit 208, a network interface, and input/output interfaces into a single integrated device. The computing system 202 may implement an operating system for managing various aspects of the operation. While one processor 204, one CPU 206, and one memory 208 is shown in FIG. 2, of course more than one of each can be utilized in an overall system.

The memory unit 208 may include volatile memory and non-volatile memory for storing instructions and data. The non-volatile memory may include solid-state memories, such as NAND flash memory, magnetic and optical storage media, or any other suitable data storage device that retains data when the computing system 202 is deactivated or loses electrical power. The volatile memory may include static and dynamic random-access memory (RAM) that stores program instructions and data. For example, the memory unit 208 may store a machine learning model 210 or algorithm, a training dataset 212 for the machine learning model 210, raw source dataset 216.

The computing system 202 may include a network interface device 222 that is configured to provide communication with external systems and devices. For example, the network interface device 222 may include a wired and/or wireless Ethernet interface as defined by Institute of Electrical and Electronics Engineers (IEEE) 802.11 family of standards. The network interface device 222 may include a cellular communication interface for communicating with a cellular network (e.g., 3G, 4G, 5G, 6G). The network interface device 222 may be further configured to provide a communication interface to an external network 224 or cloud.

The external network 224 may be referred to as the world-wide web or the Internet. The external network 224 may establish a standard communication protocol between computing devices. The external network 224 may allow information and data to be easily exchanged between computing devices and networks. One or more servers 230 may be in communication with the external network 224. In some embodiments, the external network may include cellular communications between units thereof. For example, the wireless interior sensing system of a vehicle may communicate through cellular communications with server 230 via a cellular network implemented by external network 224.

The computing system 202 may include an input/output (I/O) interface 220 that may be configured to provide digital and/or analog inputs and outputs. The I/O interface 220 is used to transfer information between internal storage and external input and/or output devices (e.g., HMI devices). The I/O 220 interface can includes associated circuitry or BUS networks to transfer information to or between the processor(s) and storage. For example, the I/O interface 220 can include digital I/O logic lines which can be read or set by the processor(s), handshake lines to supervise data transfer via the I/O lines; timing and counting facilities, and other structure known to provide such functions. Examples of input devices include a key board, mouse, sensors (including wireless sensors), etc. Examples of output devices include monitors, printers, speakers, etc. The I/O interface 220 may include additional serial interfaces for communicating with external devices (e.g., Universal Serial Bus (USB) interface). The I/O interface 220 can be referred to as an input interface (in that it transfers data from an external input, such as a sensor), or an output interface (in that it transfers data to an external output, such as a display).

The computing system 202 may include a human-machine interface (HMI) device 218 that may include any device that enables the system 200 to receive control input. Examples of input devices may include human interface inputs such as keyboards, mice, touchscreens, voice input devices, and other similar devices. The computing system 202 may include a display device 232. The computing system 202 may include hardware and software for outputting graphics and text information to the display device 232. The display device 232 may include an electronic display screen, projector, printer or other suitable device for displaying information to a user or operator. The computing system 202 may be further configured to allow interaction with remote HMI and remote display devices via the network interface device 222.

The system 200 may be implemented using one or multiple computing systems. While the example depicts a single computing system 202 that implements all of the described features, it is intended that various features and functions may be separated and implemented by multiple computing units in communication with one another. The particular system architecture selected may depend on a variety of factors.

The system 200 may implement a machine learning algorithm 210 that is configured to analyze the raw source dataset 216. The raw source dataset 216 may include raw or unprocessed sensor data that may be representative of an input dataset for a machine learning system. The raw source dataset 216 may include video, video segments, images, text-based information, audio or human speech, time series data (e.g., a pressure sensor signal over time), raw or partially processed sensor data (e.g., radar map of objects), wireless signals in terms of CSI, RSSI, CIR. Moreover, the raw source dataset 216 may be input data derived from an associated sensor such as a camera, LiDAR, radar, ultrasonic sensor, motion sensor, thermal imaging camera, wireless receivers, or any other type of sensor that produces associated data with spatial dimensions where there is some notion of a “foreground” and a “background” within those spatial dimensions. References to an input or input “image” herein is not necessarily from a camera, but can be from any of the above-listed sensors. Several different examples of inputs are shown and described with reference to the other figures discussed below. In some examples, the machine learning algorithm 210 may be a neural network algorithm (e.g., deep neural network) that is designed to perform a predetermined function. For example, the neural network algorithm may be configured to identify defects (e.g., cracks, stresses, bumps, etc.) in a part subsequent to the manufacture of that part but prior to leaving the plant.

The computer system 200 may store a training dataset 212 for the machine learning algorithm 210. The training dataset 212 may represent a set of previously constructed data for training the machine learning algorithm 210. The training dataset 212 may be used by the machine learning algorithm 210 to learn weighting factors associated with a neural network algorithm. The training dataset 212 may include a set of source data that has corresponding outcomes or results that the machine learning algorithm 210 tries to duplicate via the learning process.

The machine learning algorithm 210 may be operated in a learning mode using the training dataset 212 as input. The machine learning algorithm 210 may be executed over a number of iterations using the data from the training dataset 212. With each iteration, the machine learning algorithm 210 may update internal weighting factors based on the achieved results. For example, the machine learning algorithm 210 can compare output results (e.g., a reconstructed or supplemented image, in the case where image data is the input) with those included in the training dataset 212. Since the training dataset 212 includes the expected results, the machine learning algorithm 210 can determine when performance is acceptable. After the machine learning algorithm 210 achieves a predetermined performance level (e.g., 100% agreement with the outcomes associated with the training dataset 212), or convergence, the machine learning algorithm 210 may be executed using data that is not in the training dataset 212. It should be understood that in this disclosure, “convergence” can mean a set (e.g., predetermined) number of iterations have occurred, or that the residual is sufficiently small (e.g., the change in the approximate probability over iterations is changing by less than a threshold), or other convergence conditions. The trained machine learning algorithm 210 may be applied to new datasets to generate annotated data.

The machine learning algorithm 210 may be configured to identify a particular feature in the raw source data 216. The raw source data 216 may include a plurality of instances or input dataset for which supplementation results are desired. The machine learning algorithm 210 may be programmed to process the raw source data 216 to identify the presence of the particular features. The machine learning algorithm 210 may be configured to identify a feature in the raw source data 216 as a predetermined feature. The machine learning algorithm may be further configured to determine, within the vehicle setting of the present disclosure, human occupancy, gestures by human occupants, breathing patterns, and so on. The raw source data 216 may be derived from a variety of sources. For example, the raw source data 216 may be actual input data collected by a machine learning system. The raw source data 216 may be machine generated for testing the system. As an example, the raw source data 216 may include raw video images from a camera.

Some implementations of computer system 202 are in a vehicle that includes a wireless interior sensing system. The wireless interior sensing system may utilize computer system 200 to carry out the various data processing functions of data based on wireless signals transmitted within the vehicle. Furthermore, the wireless interior sensing system may utilize results of processed data to carry out various control functions of the wireless interior sensing system, such as controlling certain transmitter parameters and/or certain parameters of RIS, as discussed elsewhere herein.

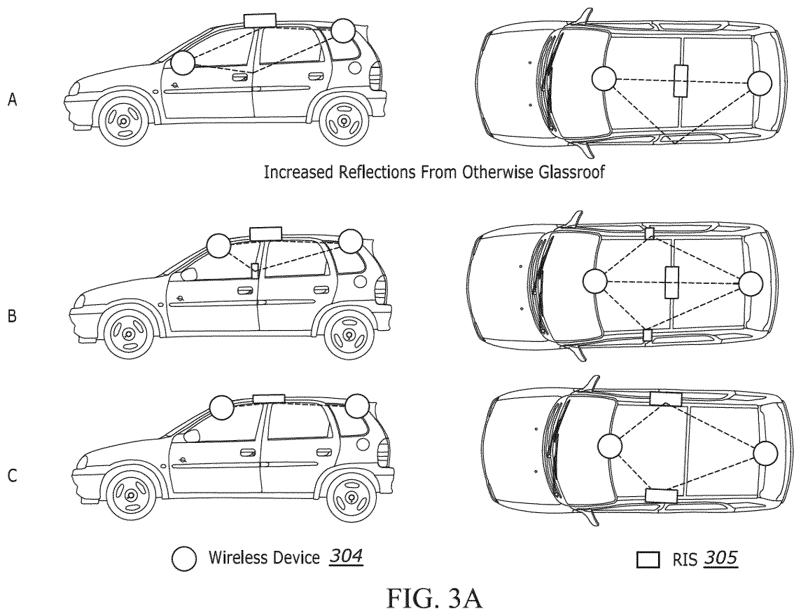

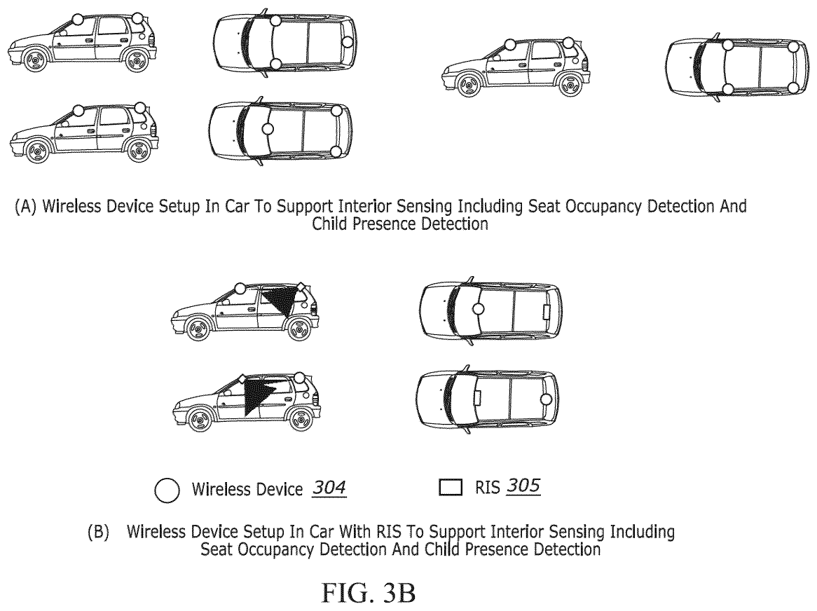

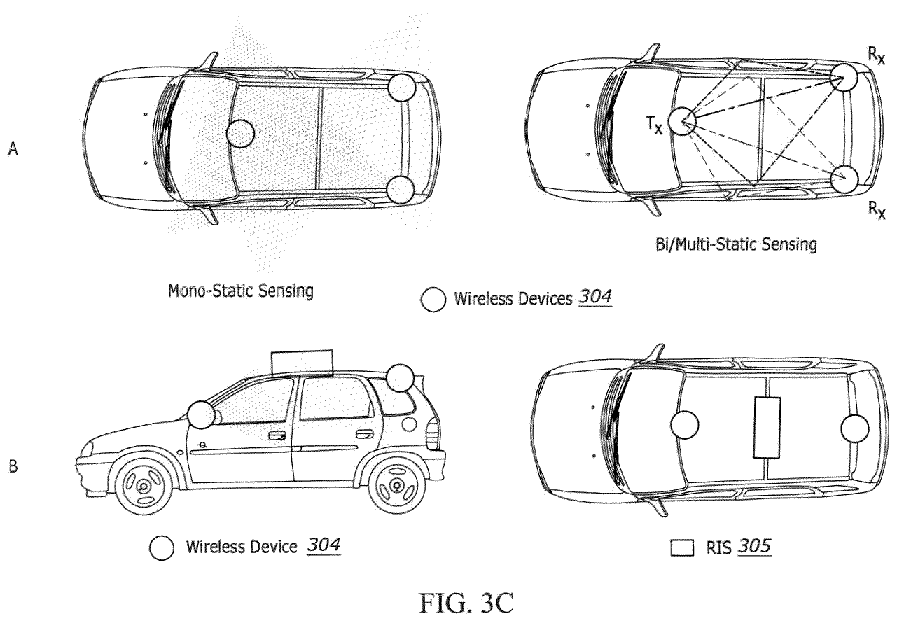

FIG. 3A is an illustration of various arrangements of wireless devices and at least one RIS unit for carrying out the sensing functions of a wireless interior sensing system for a vehicle as disclosed herein. Each of configurations A, B, and C as shown here include at least one RIS unit 305 and at least two wireless devices 304. In some implementations, one of the wireless devices is a transmitter while the other wireless device is a receiver. In other implementations, both wireless devices are transceivers, capable of carrying out both transmission and reception of wireless signals, which may lead to increased granularity in the wireless sensing of the vehicle interior environment.

Each of the examples also shows possible signal paths for reflected wireless signals (whereas line of sight signal paths are a substantially straight line between a transmitter and a receiver, and are not explicitly shown here). These reflective paths include reflections from the surfaces of the corresponding RIS units 305, but may also include reflections off of windows and other interior surfaces of the vehicle.

FIG. 3B illustrates additional examples of wireless device setup in both examples A and B thereof. The examples shown in A may support sensing for seat occupancy detection as well as child presence detection, and may include a number of wireless devices 304 (e.g., three or four) beyond the two shown in the example of FIG. 3A. As with that example, the wireless devices 304 may be transmitters, receivers, or transceivers, although each example will include both transmission and reception capabilities.

In example B of FIG. 3B, only a single wireless device 304 and a single RIS unit 305 is shown. The single wireless device 304 in this example may act as an interior radar, including both transmission and reception function. The wireless device 304 and RIS unit 305 in this embodiment (as well as others) may work in conjunction with one another to control the propagation of wireless signals in the interior of the vehicle. This may include controlling the transmission power, signal frequency, and beam direction of a transmitter, as well as the frequency selectivity and reflection angle of the various configurable reflective surfaces of RIS unit 305.

FIG. 3C illustrates additional examples of wireless device and RIS unit arrangements in a vehicle. Example A shows illustrating a difference between mono-static sensing and bi/multi-static sensing using a transmitter and multiple receivers. In both parts of Example A, no RIS unit 305 is present. However, in Example B, a single RIS unit 305 is present, and may thus enable implementation of the system with fewer wireless devices 304, providing full coverage within the vehicle interior while using monostatic sensing.

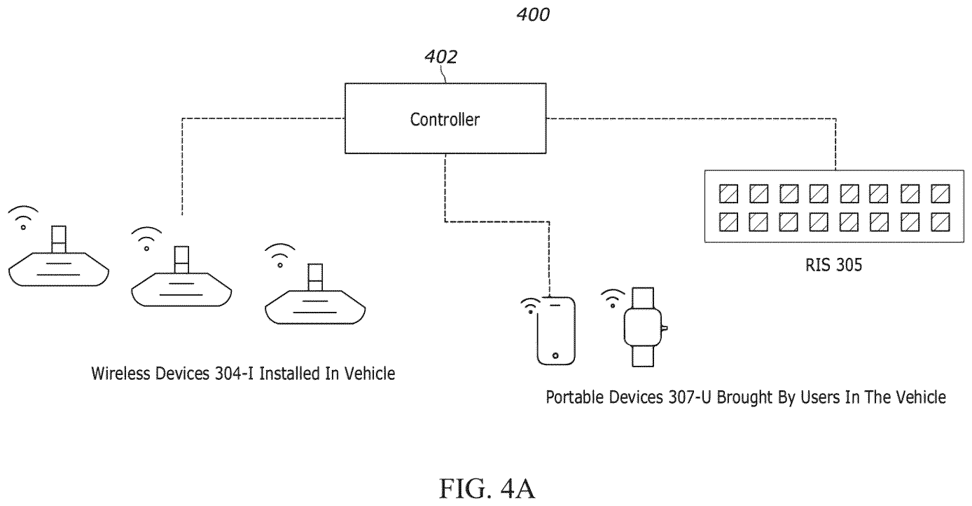

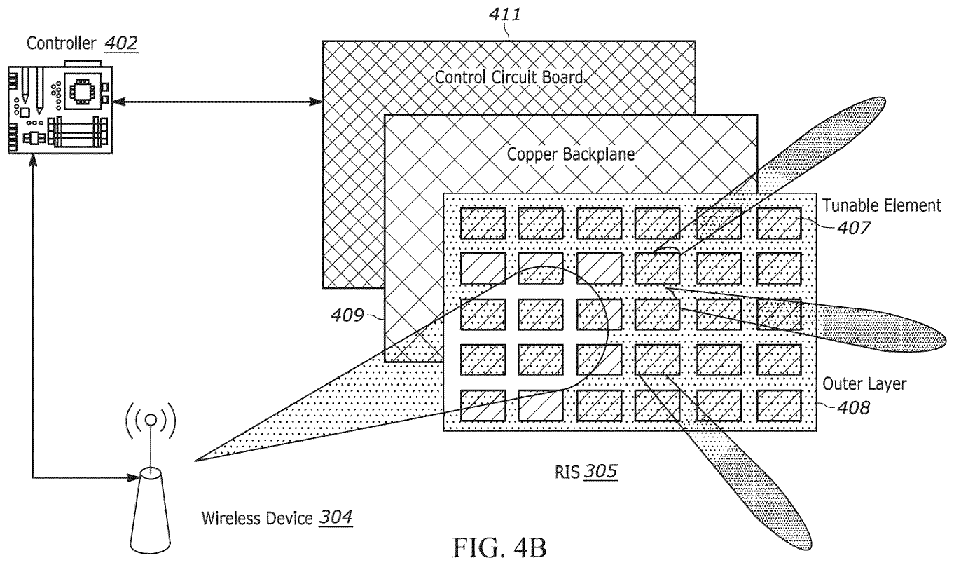

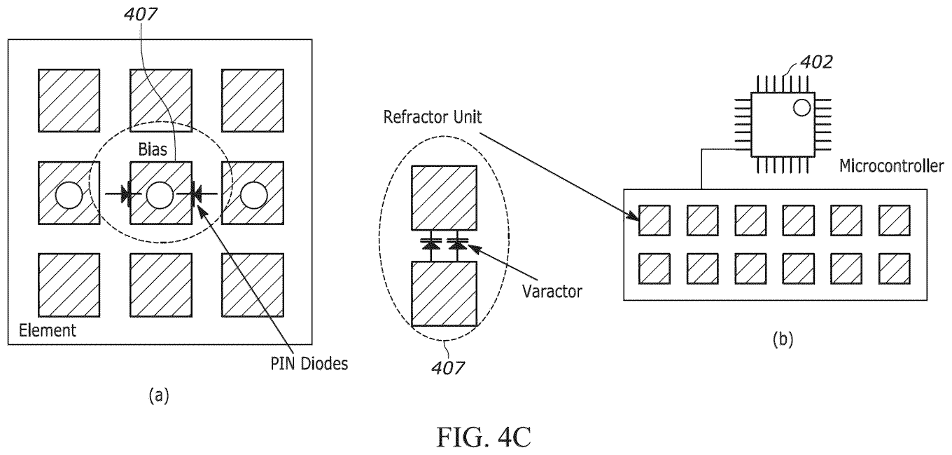

FIG. 4A shows a system for performing in-cabin sensing in a vehicle. In the embodiment shown, system 400 is a vehicle interior sensing system suitable to perform the various interior sensing functions discussed elsewhere herein. The system includes a controller 402, a number of wireless devices 304-I (installed in the vehicle interior itself), and at least one RIS unit 305. System 400 as shown here may also be augmented by portable devices 307-U that may be brought into the vehicle by its occupants. Such devices may include cellular phones, smartwatches, tablet computers, laptop computers, and so on.

Controller 402 may in various implementations be part of, e.g., computer system 200 of FIG. 2, or other systems disclosed herein. Accordingly, controller 402 may execute various machine learning models to carry out its various control functions. Such control functions include the switching on/off and functions of RIS unit 305 and the various elements thereof, comparisons of data generated by wireless signals received via line of sight and those received via reflections from, e.g., the reconfigurable reflective surfaces of RIS unit 305. Additional control functions may include controlling transmitter, receiver, and RIS parameters for the purposes of controlling signal propagation. For example, controller 402 may perform beamforming for transmitted wireless signals in order to direct some of these signals along a line of sight trajectory and direct other ones of these signals along a trajectory towards the reconfigurable reflective surfaces of RIS unit 305. Controller 402 may also control parameters of the reconfigurable reflective surfaces of RIS unit 305, such as frequency selectivity, reflection angle, and so on. In various embodiments, controller 402 may be integrated in RIS unit 305, another wireless device, or other computing module in the vehicle. The connection between controller 402 and RIS unit 305 may be wired (I2C, LIN, CAN, Ethernet etc.) or low-power wireless (BLE, 802.15.4, 5G/6G reduced capability devices, etc.). The connection between controller 402 and other devices could also be wired (CAN, I2C, LIN, Ethernet, etc.) or wireless (BLE, Wi-Fi, 5G/6G, 802.15.4, UWB, radio access technology, etc.)

The wireless devices 304-I as shown in FIG. 4A includes at least one transmitter and at least one receiver. In some embodiments, the wireless devices may be transceivers, having both transmission and reception capability, and thus enabling bi-directional sensing. The wireless devices 304-I may operate according to any suitable wireless protocol and at any suitable frequency for performing the desired interior sensing functions. In various embodiments, the wireless devices 304-I may include dedicated monostatic radars or wireless devices including 6G, Wi-Fi or UWB, with or without integrated sensing capability.

It is further contemplated that the wireless devices 304-I may also carry out various wireless connectivity functions, such as WiFi connections to the various portable devices 307-U that may be in the vehicle. In some implementations, the various wireless devices 304-I may query the portable devices 307-U in carrying out the various sensing functions. For examples, signals transmitted from a portable device 307-U in response to a query from one of wireless devices 304-I may be received by one or more receivers, with information obtained therefrom (e.g., received signal strength indicator, or RSSI) providing additional information or confirmation with regard to the occupants in the vehicle.

RIS unit 305 in the embodiment shown may be active or passive powered by vehicle (battery) or dedicated battery (single use or rechargeable) or energy harvesters (potentially in combination with rechargeable batteries or super capacitors). For automotive use cases, pre-determined configurations can be loaded from the controller based on the use case. As will be explained in further detail below, RIS unit 305 may include one or more reconfigurable reflective surfaces/tunable elements.

FIG. 4B shows another example of a system for performing in-cabin sensing in a vehicle. In particular, FIG. 4B illustrates additional details of one implementation of a RIS unit 305. In the illustrated example, RIS unit 305 includes an outer layer 408 having a plurality of reflecting elements 407 (i.e. reconfigurable reflective surfaces), a copper backplane 409, and a control circuit board 411. The control circuit board 411 is coupled to controller 402, and may receive control signals therefrom. The controller is further coupled to wireless device 304 in this example, and may be coupled to one or more additional wireless devices.

Outer layer 408 as shown here includes a number of reflecting elements 407 printed on a dielectric substrate to directly act on the incident wireless signals. Each of the reflecting elements 407 is dynamically configurable (by controller 402, via control circuit board 411) to introduce a variable phase shift to an outgoing (reflected) signal. In one implementation, an approach to controlling the phase shift is to control the metasurface switches in a diode array, such as an array of positive-intrinsic-negative (PIN) diodes or varactor diodes. By adjusting the phase shift of the various elements 407, wireless signals may be reflected therefrom in a specific direction.

Copper backplane 409 as shown here is a copper panel to avoid signal/energy leakage. Control circuit board 411 is a circuit board that used for tuning the reflection coefficients of the reflecting elements 407 on outer layer 408. Control circuit board 411 may be operated by controller 402, such as a field programmable gate array (FPGA), and may be coupled to other computing devices in the vehicle.

FIG. 4C illustrates example embodiments of a RIS unit 305 each having a number of reflecting elements 407. In example (a), the reflecting elements 407 are based on PIN diodes. In example (b), the reflecting elements are based on varactors. In various embodiments, the reflecting elements 407 may be implemented in different ways and in different configurations. Such reflecting elements 407 for an adjustment of a phase shift of a reflected signal. By adjusting the phase shift of each reflecting element 407, the RIS unit 305 can direct the reflection signal to a specific direction.

In addition to the examples shown in FIG. 4C, the reflecting elements 407 may be implemented in other ways and may take on various characteristics. At a high level, various embodiments of a RIS unit 305 can be categorized as active and passive, as well as discrete or continuous. An active RIS unit 305 uses energy-intensive RF circuits and consecutive signal processing units embedded in the surface of the tunable elements 407. An active RIS unit 305 can be implemented with holographic metasurface aperture or discrete photonic antenna array (comprising active optical-electrical detectors, converters, and modulators).

A passive RIS unit 305 may be composed of low-cost and almost passive elements that do not require dedicated power sources. Therefore, a passive RIS unit 305 requires very low power and thus can be powered using energy harvesters or rechargeable batteries. As there is no active operation in radio waves reflection, a passive RIS unit 305 may support full-duplex communication as an added advantage with no additional cost. In general, a passive RIS unit 305 may be easier to deploy compared to active RIS unit 305. Another potential option is to utilize varactors in RIS units 305 where their capacitance is affected by incoming radio waves. Such a setup may absorb some RF energy while reflecting most of it. This design is referred to as hybrid RIS unit.

A discrete RIS unit 305 is a discrete holographic multiple input, multiple output surface (HMIMOS) that may comprise many discrete unit cells/tunable elements made of low-power and software-tunable metamaterials. The discrete meta-atoms can be realized in many ways ranging from off the shelf electronic components (e.g., PIN diodes, varactor diodes) to using liquid crystals, microelectromechanical systems (MEMS) or even electromechanical switches, and other reconfigurable metamaterials. These realizations may control the switch for tunable elements of the RIS unit 305 with various mechanisms, e.g., a voltage source, electric field, magnetic field, thermal variations, light, external pressure, electro-optical, etc. In contrast, a contiguous RIS unit 305 (i.e. one single, large tunable element) can thus form a spatially continuous transceiver aperture by integrating a virtually infinite number of elements into a limited surface area.

The phase tuning mechanism of RIS units may depend on the hardware implementation as outlined in the following paragraphs.

Frequency-selective surfaces: In frequency-selective surfaces, each tunable element is embedded with a PIN diode. By varying the biasing voltage, the PIN diode can be switched between the two states, i.e., ON and OFF, realizing a phase-shift of a in radians. In general, to realize K phase-shift levels, log₂K diodes are required. Due to the limited size of tunable RIS elements and greater number of pins required to control each element, it may be impractical to utilize the general case in some implementations. Accordingly many implementations may utilize discrete phase-shifts.

Varactor-tuned resonators: The use of varactor-tuned resonators is another approach for realizing the RIS phase configuration. The basic idea of this implementation is to change the resonant frequency of each element, which can be achieved by embedding a tunable capacitor in each element, thus the desired phase-shift is realized by varying the biasing voltage across the capacitor. A varactor diode may be adopted to achieve a continuous reflection phase shift.

Liquid-crystal based reflectors: The real time reconfiguration of RIS elements can be achieved through functional materials, such as liquid crystals and graphene. The reconfigurability is achieved by varying the direct current voltage across the liquid crystal filled elements, as a result the dielectric constant of each element can be adjusted in real time.

Microelectromechanical Sensors (MEMS): For some embodiments, when the operating frequency of the transmitters and receivers is in the millimeter-wave band, the MEMS switches become a promising alternative to the PIN diodes, since the latter may introduce larger insertion losses. Also, the capacitance variation MEMS exhibits may be large enough that they can reliably approximate ideal switches.

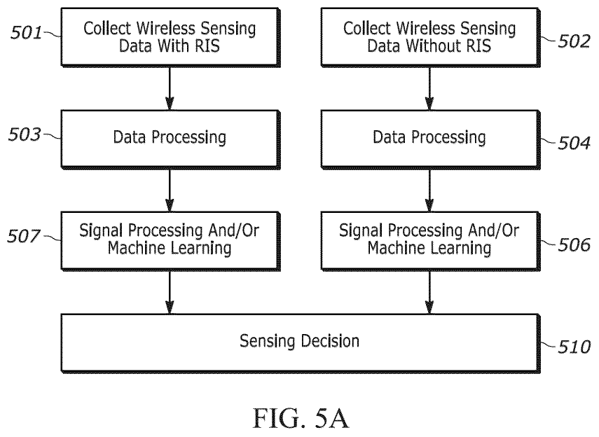

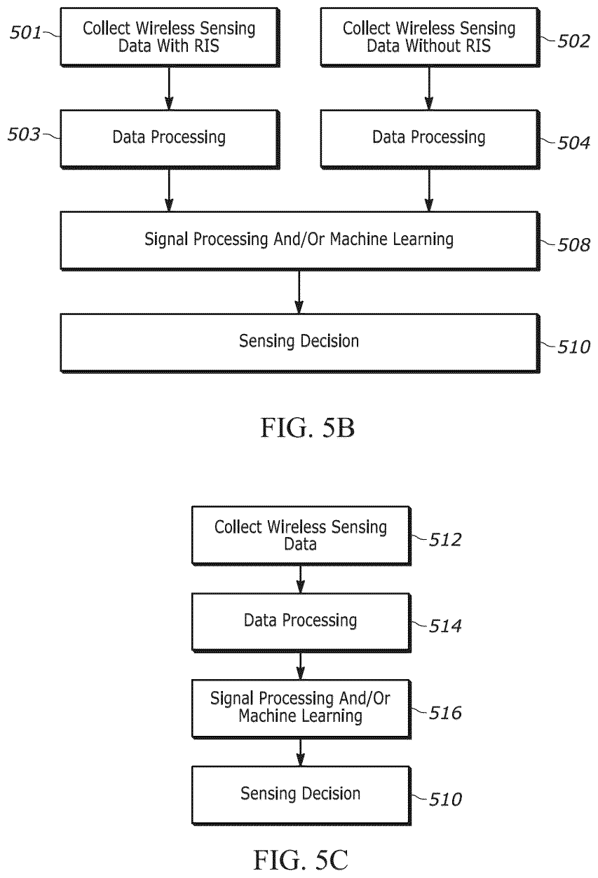

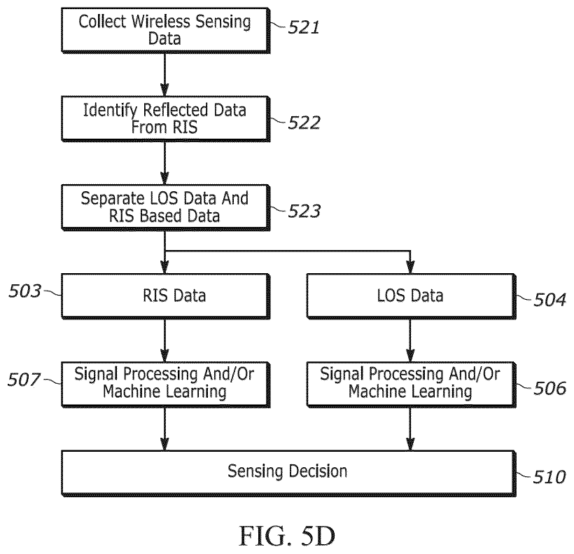

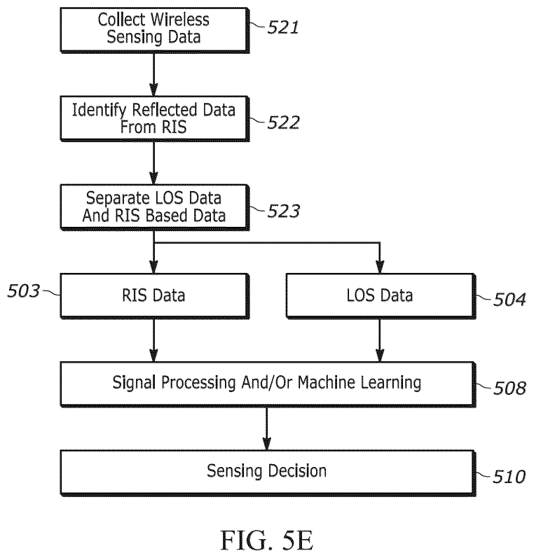

FIGS. 5A-5E show various examples of a method for performing in-cabin sensing in a vehicle in accordance with the disclosure. Each of the various embodiments shown in these figures illustrate different ways in which data can be processed based on the transmission and reception of wireless signals within a vehicle to arrive at a sensing decision.

In FIG. 5A, reflected wireless data with RIS (501) and without RIS (502) is collected at a receiver. Data processing is performed separately for the RIS data (503) and the non-RIS data (504), followed by corresponding processing and machine learning (507 and 506, respectively) for the separately processed data. Both data sets are then combined to arrive at a sensing decision.

In FIG. 5B, the collection of wireless data and data processing is performed as in the embodiment of FIG. 5A. However, both datasets are then combined for further signal processing and/or machine learning in 508, with the sensing decision (510) arrived at based thereon.

In the embodiment of FIG. 5C, the data for both with and without RIS is collected together (512), followed by the processing (514), signal processing/machine learning (516), and a sensing decision (510). In this embodiment, wireless transmissions may be conducted while concurrently using both LOS and RIS, without making any distinction between the two at the various processing stages.

In FIG. 5D, wireless transmissions and receptions may be carried out concurrently using both LOS and RIS (521). After reception, an identification of which receptions correspond to signals reflected using RIS is made (522), with a subsequent step of separating LOS and RIS data from one another (block 523). After separating, RIS data processing (503) and LOS data processing (504) are performed separately, followed by signal processing/machine learning performed for each (507 for RIS, 506 for LOS). Thereafter, the data is combined to arrive at a sensing decision. FIG. 5E illustrates a similar embodiment to FIG. 5D, with the signal processing/machine learning (508) being carried out on the combined RIS data and LOS data.

In various ones of the embodiments above, sensing may be performed in different ways. For example, in FIGS. 5A and 5B, sensing may be performed twice, once with RIS enabled, and once with RIS disabled. The benefit of this approach is that it is easier to make distinctions between sensing performance of RF signal leaking out of the vehicle and when RF signal is focused more inside the vehicle. Such a system could make it easier to determine whether activity is performed by a person just outside the vehicle or the one inside the vehicle. In such a case, the data is collected at two different times as such can be processed separately but decision is fused together. In another possibility data can also be processed and fused together for classification/detection (e.g., using a machine learning model) of sensing state.

In various embodiments, such as those shown in FIGS. 5C, 5D, and 5E, sensing may be performed with RIS enabled such that RIS data and LOS data are captured concurrently. This may be more efficient in certain situations, particularly from the standpoint of time.

Generally speaking, the various sensing methodologies disclosed herein involve several steps, irrespective of whether LOS and RIS data are collected together or separately. The collecting of wireless data may include activation of several monostatic sensing devices in different bands simultaneously, or in a same band while taking turns to collect data. Wireless devices may also be activated to operate in bi-static or multi-static sensing modes.

The various embodiments may also include identification of the data reflected by elements of a RIS unit, which may be carried out using various methodologies. One way to achieve this is by performing range Fast Fourier Transform (FFT). Using such a methodology, the first k-shortest ranges could represent LOS data while the remaining ones above a given threshold represents RIS data. Other identification processes are also possible and contemplated.

After identification, the data for LOS and RIS may be separated and placed into two different pipelines. The separate data may be provided into the respective pipelines along with time information to ensure timing synchronicity between the two. The signal processing and machine learning in various embodiments could include classification (e.g., Trees, SVM, GradientBoost, Random Forest, kNN, etc.) or neural networks-based (e.g., CNN, DNN, transformers, LSTM, etc.) methods to determine sensing state. After determination of the sensing state, a sensing decision may be made, and a target module may be informed. This could include, for example, informing an occupant of the vehicle about an internal state (e.g., occupants have changed positions), activation of system lights, or another user interface feature.

When utilizing RIS data for sensing, additional signal processing may be required to correct angle or phase information for the signal expected to be reflected from RIS device. For active RIS, we could directly use the phase shifts used/introduced by RIS components while for passive RIS, the compensation could be predetermined. For robust performance, the system could also be trained to determine correct angle/phase compensation.

In addition to robust communication performance for high frequency communication used for certain protocols, such 5G/6G and/or Wi-Fi, several sensing applications may be implemented by using RIS. Sensing applications may be divided into mono-static sensing (e.g., radar) or bi/multi-static sensing (e.g., single transmitter and one or more receivers utilizing channel state information of received RF message; see FIGS. 3A and 3C for an example embodiment). For a bi-static sensing, there is one Tx-Rx pair while for multi-static sensing there is one transmitter and multiple receivers at a given time. Automotive interior sensing applications could include intrusion detection, gesture recognition, seat occupancy detection, child left behind detection, activity detection, etc.

RIS used for sensing applications could be passive when coverage area is pre-determined and supported applications are less. However, to support multiple applications with different coverage areas an active RIS could be more useful.

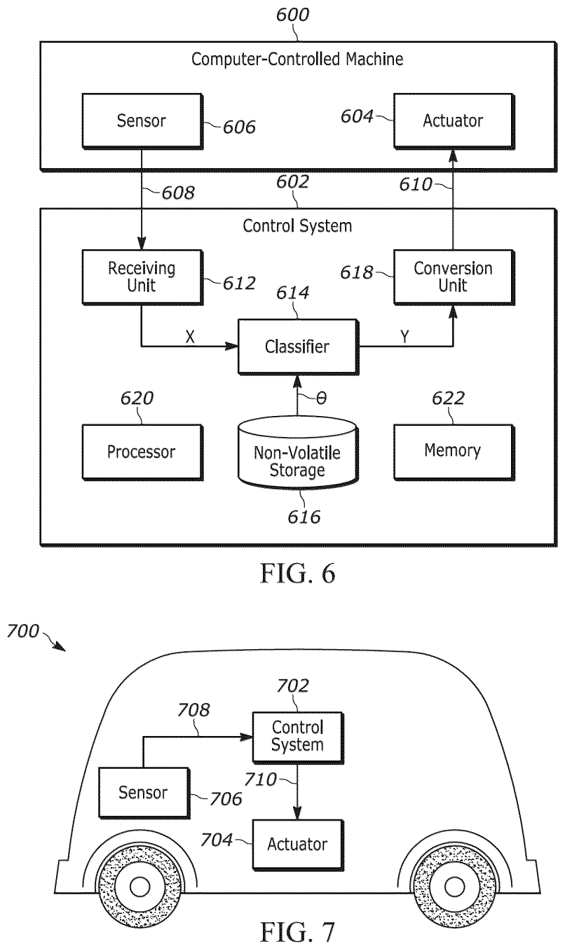

FIG. 6 depicts a schematic diagram of an interaction between a computer-controlled machine 600 and a control system 602. Computer-controlled machine 600 includes actuator 604 and sensor 606. Actuator 604 may include one or more actuators and sensor 606 may include one or more sensors. Sensor 606 is configured to sense a condition of computer-controlled machine 600. Sensor 606 may be configured to encode the sensed condition into sensor signals 608 and to transmit sensor signals 608 to control system 602. Non-limiting examples of sensor 606 include wireless receivers, video, radar, LiDAR, ultrasonic and motion sensors, as described above with reference to FIGS. 1-2. In one embodiment, sensor 606 is a wireless sensor configured to sense an environment in the interior of a vehicle using wireless signals received from line of sight (between a receiver and a transmitter) and via reflections from RIS. The sensor (or sensors) in such an embodiment are proximate to computer-controlled machine 600. Embodiments in which a combination of different sensors are also possible and contemplated.

The wireless signals transmitted and received in the interior of the vehicle may be of any suitable type and conform to any suitable wireless standard for the corresponding tasks. Accordingly, sensor 606 is in some implementations a wireless signal receiver configured to receive wireless signals from a transmitter (e.g., Wi-Fi). Computer-controlled machine 600 may utilize the received wireless signals for various interior sensing functions that make up a sensing state as defined above. The sensing state may include information about the environment of the vehicle interior, including number and type of occupants, and may also include personal identification.

Control system 602 is configured to receive sensor signals 608 from computer-controlled machine 600. As set forth below, control system 602 may be further configured to compute actuator control commands 610 depending on the sensor signals and to transmit actuator control commands 610 to actuator 604 of computer-controlled machine 600.

As shown in FIG. 6, control system 602 includes receiving unit 612. Receiving unit 612 may be configured to receive sensor signals 608 from sensor 606 and to transform sensor signals 608 into input signals x. In an alternative embodiment, sensor signals 608 are received directly as input signals x without receiving unit 612. Each input signal x may be a portion of each sensor signal 608. Receiving unit 612 may be configured to process each sensor signal 608 to product each input signal x. Input signal x may include data corresponding to an image recorded by sensor 606.

Control system 602 includes a classifier 614. Classifier 614 may be configured to classify input signals x into one or more labels using a machine learning (ML) algorithm, such as a neural network described above. Classifier 614 is configured to be parametrized by parameters, such as those described above (e.g., parameter θ). Parameters θ may be stored in and provided by non-volatile storage 616. Classifier 614 is configured to determine output signals y from input signals x. Each output signal y includes information that assigns one or more labels to each input signal x. Classifier 614 may transmit output signals y to conversion unit 618. Conversion unit 618 is configured to covert output signals y into actuator control commands 610. Control system 602 is configured to transmit actuator control commands 610 to actuator 604, which is configured to actuate computer-controlled machine 600 in response to actuator control commands 610. When implemented in an interior vehicle sensing system, such actuator commands may be used to control various parameters of a transmitter for transmitting wireless signals (e.g., transmission power, frequency, beam shape, etc.). Actuator commands may also be used to control parameters (e.g., frequency selectivity, reflectivity, etc.) of RIS as discussed elsewhere herein.

Upon receipt of actuator control commands 610 by actuator 604, actuator 604 is configured to execute an action corresponding to the related actuator control command 610. Actuator 604 may include a control logic configured to transform actuator control commands 610 into a second actuator control command, which is utilized to control actuator 604. In one or more embodiments, actuator control commands 610 may be utilized to control a display instead of or in addition to an actuator.

In another embodiment, control system 602 includes sensor 606 instead of or in addition to computer-controlled machine 600 including sensor 606. Control system 602 may also include actuator 604 instead of or in addition to computer-controlled machine 600 including actuator 604.

As shown in FIG. 6, control system 602 also includes processor 620 and memory 622. Processor 620 may include one or more processors. Memory 622 may include one or more memory devices. The classifier 614 of one or more embodiments may be implemented by control system 602, which includes non-volatile storage 616, processor 620 and memory 622.

Non-volatile storage 616 may include one or more persistent data storage devices such as a hard drive, optical drive, tape drive, non-volatile solid-state device, cloud storage or any other device capable of persistently storing information. Processor 620 may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory 622. Memory 622 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information.

Processor 620 may be configured to read into memory 622 and execute computer-executable instructions residing in non-volatile storage 616 and embodying one or more ML algorithms and/or methodologies of one or more embodiments. Non-volatile storage 616 may include one or more operating systems and applications. Non-volatile storage 616 may store compiled and/or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

Upon execution by processor 620, the computer-executable instructions of non-volatile storage 616 may cause control system 602 to implement one or more of the ML algorithms and/or methodologies as disclosed herein. Non-volatile storage 616 may also include ML data (including data parameters) supporting the functions, features, and processes of the one or more embodiments described herein.

The program code embodying the algorithms and/or methodologies described herein is capable of being individually or collectively distributed as a program product in a variety of different forms. The program code may be distributed using a computer readable storage medium having computer readable program instructions thereon for causing a processor to carry out aspects of one or more embodiments. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments.

The processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

FIG. 7 depicts a schematic diagram of control system 602 configured to control vehicle 700, which may be an at least partially autonomous vehicle or an at least partially autonomous robot. Vehicle 700 includes actuator 604 and sensor 606. Sensor 606 may include one or more video sensors, cameras, radar sensors, ultrasonic sensors, wireless transmitters and/or receivers, LiDAR sensors, and/or position sensors (e.g., GPS). One or more of the one or more specific sensors may be integrated into vehicle 700. Alternatively or in addition to one or more specific sensors identified above, sensor 606 may include a software module configured to, upon execution, determine a state of actuator 604. The wireless sensors implemented within sensor 606 may include sensors for performing, e.g., interior and/exterior sensing in accordance with the discussion above, which may be augments using reflected surfaces such as the RIS of the present disclosure.

Classifier 614 of control system 602 of vehicle 700 may be configured to detect objects in the vicinity of vehicle 700 dependent on input signals x. In such an embodiment, output signal y may include information characterizing the vicinity of objects to vehicle 700. Actuator control command 610 may be determined in accordance with this information. The actuator control command 610 may be used to avoid collisions with the detected objects. In some embodiments, classifier 614 may utilize wireless signals in the vehicle for various sensing applications and the determination of a sensing state within the vehicle. Determination of the sensing state may include determining a number of occupants of the vehicle, classification of various occupants (e.g., adult, child, pet), and so on. For example, classifier 614 may utilize the wireless signals to identify the approximate size of a driver of a car (when the vehicle is a car), thereby enabling control system 602 to adjust a seat position for the driver upon entry into the vehicle.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

1. A method for controlling signal propagation in a wireless vehicle interior sensing system, the method comprising:
transmitting wireless signals using a transmitter implemented in the interior of a vehicle;
reflecting at least a portion of the wireless signals using a plurality of configurable reflective surfaces implemented within the vehicle;
receiving, at a first receiver, the wireless signals, wherein the wireless signals include wireless signals conveyed via a line of sight between the transmitter and the first receiver and wireless signals reflected using the plurality of configurable reflective surfaces;
comparing data generated based on receiving the wireless signals conveyed via the line of sight to data generated based on the portion of the wireless signals reflected using the plurality of configurable reflective surfaces;
determining a sensing state based on the comparing, wherein the sensing state includes determining a presence in the interior of the vehicle; and
adjusting operating parameters of the transmitter based on the sensing state, wherein the operating parameters of the transmitter include controlling a direction of beams of wireless signals transmitted by the transmitter.

2. The method of claim 1, further comprising adjusting operating parameters of the plurality of configurable reflective surfaces based on the sensing state, wherein adjusting the operating parameters of the plurality of configurable reflective surfaces comprises changing a resonant frequency of ones of the plurality of configurable reflective surfaces.

3. The method of claim 1, further comprising adjusting operating parameters of the plurality of configurable reflective surfaces based on the sensing state, wherein adjusting the operating parameters of the plurality of configurable reflective surfaces comprises varying a direct current voltage across a liquid crystal element of ones of the plurality of configurable reflective surfaces.

4. The method of claim 1, wherein adjusting the operating parameters of the plurality of configurable reflective surfaces comprises causing a phase shift in a frequency of the wireless signals reflected off the configurable reflective surfaces, wherein causing the phase shift comprises the control system to vary a bias voltage on a PIN diode on corresponding ones of the configurable reflective surfaces.

5. The method of claim 1, wherein adjusting the operating parameters of the plurality of configurable reflective surfaces comprises varying a capacitance of microelectromechanical systems of ones of the plurality of configurable reflective surfaces.

6. The method of claim 1, further comprising:
performing a first sensing iteration, wherein performing the first sensing iteration comprises transmitting and receiving wireless signals while the plurality of configurable reflective surfaces are disabled; and
performing a second sensing iteration, wherein performing the second sensing iteration comprises transmitting and receiving wireless signals while the plurality of configurable reflective surfaces are enabled;
wherein the comparing comprises comparing data generated during the first iteration to data generated during the second iteration.

7. The method of claim 1, further comprising receiving the wireless signals at a plurality of receivers including the first receiver.

8. The method of claim 1, wherein determining the sensing state comprises determining a presence of occupants of the vehicle.

9. The method of claim 1, further comprising:
determining the sensing state using a first sensing application having a first coverage area;
changing, by adjusting ones of the plurality of configurable reflective surfaces, to a second coverage area, the second coverage area is different than the first, wherein changing to the second area comprises changing respective directions of the beams of wireless signals transmitted by the transmitter; and
determining the sensing state using a second sensing application having the second coverage area.

10. A system for controlling signal propagation in a wireless vehicle interior sensing system, the method comprising:
a transmitter implemented in an interior of a vehicle and configured to transmit wireless signals;
a plurality of configurable reflective surfaces implemented in the vehicle and configured to reflect at least a portion of the wireless signals transmitted by the transmitter
a first receiver configured to receive the wireless signals, wherein the wireless signals include wireless signals conveyed via a line of sight between the transmitter and the first receiver, and the portion of wireless signals reflected using the plurality of configurable reflective surfaces; and
a control system coupled to the transmitter, the first receiver, and the plurality of configurable reflective surfaces, wherein the control system is configured to:
compare data generated based on receiving the wireless signals conveyed via the line of sight to data generated based on the portion of the wireless signals reflected using the plurality of configurable reflective surfaces;
determine a sensing state based on the comparing, wherein to determine the sensing state, the control system is configured to determine a presence in the interior of the vehicle; and
adjust operating parameters of the transmitter based on the sensing state, wherein the operating parameters of the transmitter include controlling a direction of beams of wireless signals transmitted by the transmitter.

11. The system of claim 10, wherein the control system is further configured to, based on the sensing state, change a resonant frequency of ones of the plurality of configurable reflective surfaces.

12. The system of claim 10, wherein the control system is further configured to, based on the sensing state, vary a direct current voltage across a liquid crystal element of ones of the plurality of configurable reflective surfaces.

13. The system of claim 10, wherein to adjust the operating parameters of the configurable reflective surfaces, the control system is configured to vary a bias on a PIN diode of ones of the plurality of configurable reflective surfaces to cause a phase shift in a frequency of the wireless signals reflected off the ones of the plurality of configurable reflective surfaces.

14. The system of claim 10, wherein to adjust the operating parameters of the configurable reflective surfaces, the control system is configured to vary a capacitance of microelectromechanical systems of ones of the plurality of configurable reflective surfaces.

15. The system of claim 10, wherein the control system is further configured to:
cause performance of a first sensing iteration, wherein causing performance of the first sensing iteration comprises disabling the plurality of reflective surfaces while the first receiver receives the wireless signals;
cause performance of a second sensing iteration, wherein causing performance of the second sensing iteration comprises enabling the plurality of reflective surfaces such that the first receiver receives the wireless signals via line of sight and via reflections from the plurality of reflective surfaces; and
compare data generated during the first iteration to data generated during the second iteration.

16. The system of claim 10, wherein the control system is further configured to identify the wireless signals reflected using the plurality of configurable reflective surfaces by performing a range Fast Fourier Transform to distinguish line of sight signals from reflected signals based on respective propagation distances.

17. The system of claim 10, further comprising a plurality of receivers including the first receiver, wherein the control system is further configured to perform comparisons based on data received by each of the plurality of wireless receivers.

18. The system of claim 10, wherein the control system is further configured to:
determine the sensing state using a first sensing application having a first coverage area;
change, by adjusting ones of the plurality of configurable reflective surfaces, to a second coverage area, the second coverage area is different than the first, wherein changing to the second area comprises changing respective directions of the beams of wireless signals transmitted by the transmitter; and
determine the sensing state using a second sensing application having the second coverage area.

19. A non-transitory computer-readable medium storing instruction that, when executed by a computing system, cause the computing system to carry out the following operations:
causing transmission of wireless signals using a transmitter implemented in an interior of a vehicle and reception of the wireless signals at a first receiver, wherein the wireless signals as received by the first receiver include wireless signals conveyed via a line of sight between the transmitter and the first receiver and wireless signals reflected using a plurality of configurable reflective surfaces;
comparing data generated based on receiving the wireless signals conveyed via the line of sight to data generated based on the portion of the wireless signals reflected using the plurality of configurable reflective surfaces;
determining a sensing state based on the comparing, wherein the sensing state includes a number of occupants in the interior of the vehicle; and
adjusting operating parameters of the transmitter and the plurality of configurable reflective surfaces based on the sensing state, wherein the operating parameters of the transmitter include controlling a direction of beams of wireless signals transmitted by the transmitter, and wherein the operating parameters of the plurality of configurable reflective surfaces include a frequency selectivity of the reflective surfaces.

20. The computer-readable medium of claim 19, wherein adjusting operating parameters of the plurality of configurable reflective surfaces include at least one of the following:
changing a resonant frequency of ones of the plurality of configurable reflective surfaces;
varying a direct current voltage across a liquid crystal element of ones of the plurality of configurable reflective surfaces;
causing a phase shift in a frequency of the wireless signals reflected off the configurable reflective surfaces, wherein causing the phase shift comprises the control system to vary a bias voltage on a PIN diode on corresponding ones of the configurable reflective surfaces.
varying a capacitance of microelectromechanical systems of ones of the plurality of configurable reflective surfaces.
